(19) United States
(12) Patent Application Publication
(10) Pub. No.: US 2007/0019250 A1
(43) Pub. Date: Jan. 25, 2007

(54) Scanner

(75) Inventor: Yi Yu Cao, Jiangsu (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/485,540

(22) Filed: Jul. 11, 2006

(30) Foreign Application Priority Data
Jul. 19, 2005 (TW) TW94124281

(51) Int. Cl. H04N 1/04

(52) U.S. Cl. 358/474

(57) ABSTRACT

A scanner. The scanner includes a display, a scan module, and a positioning mechanism. The display is actuated to provide light. The scan module includes an image sensor. The scan module is positioned on the display by the positioning mechanism, and the display is actuated to provide light for scanning a document.

### BACKGROUND

The invention relates to a scanner, and in particular, to a scanner utilizing light from a display device.

Technology is in distinct progress nowadays. Display devices are transformed from utilizing light provided by a Cathode Ray Tube (CRT), to utilizing light provided by liquid crystal material. Thus, thinner and more functional displays are performed. In response to trends toward integration of diverse electronic products into one, U.S. Pat. No. 6,307,649 discloses a scanner utilizing light from a conventional image tube display. Combining the table-top display and the flat-bed scanner, space can be saved efficiently. Nevertheless, when scanning a document, light is blocked by a scan module, reducing brightness, resulting in poor scanning quality, or even failure. Thus, a scanning device with accurate control of sufficient light from a display device is called for.

Accordingly, the invention provides a scanner utilizing light from a display device. The scanner comprises a display, a scan module, and a positioning mechanism. The scan module comprises an image sensor. The scan module is positioned on the display by the positioning mechanism, and the display is actuated to provide light for scanning a document.

The scanner further comprises a light guide disposed on a side of the image sensor, near the display.

The light guide is a converging lens, and is transparent.

The scanner further comprises a filter, disposed between the display and the image sensor, which is used to uniform the light.

The positioning mechanism comprises a hinge, and the scan module is connected to the display by the hinge.

The scanning document is a reflection target or a transmission target.

The image sensor is a focal plane array sensor or a contact image sensor.

The invention further provides a scan module for a display device, comprising a housing, a motor, a transmission mechanism, an image sensor, and a light guide. The motor and the image sensor are disposed in the housing. The transmission mechanism, disposed in the housing, is driven by the motor. The light guide disposed in the housing is near the image sensor.

The invention further provides a scan module for a display device, comprising a housing, an area imaging device, and an image sensor. The area imaging device is disposed in the housing. The image sensor disposed in the housing senses light conducted by the area imaging device.

### DESCRIPTION OF THE DRAWINGS

The invention can be more fully understood by reading the subsequent detailed description and examples with references made to the accompanying drawings, wherein:

FIG. 1A is a schematic view of a first embodiment of a scanner;

FIG. 1B is a schematic view of a second embodiment of a scanner;

FIG. 2 is a schematic view of a light guide of the scanner;

FIG. 3A is a schematic view of a third embodiment of the scanner;

FIG. 3B is a schematic view of a fourth embodiment of the scanner;

FIG. 4A is a side view of the scanner in operation; and

FIG. 4B is a side view of a stationary scanner.

### DETAILED DESCRIPTION

### First Embodiment

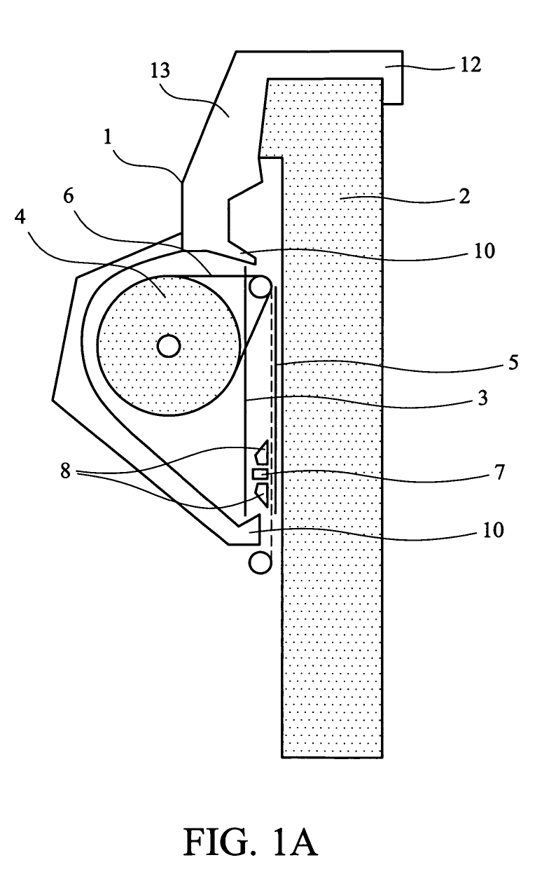

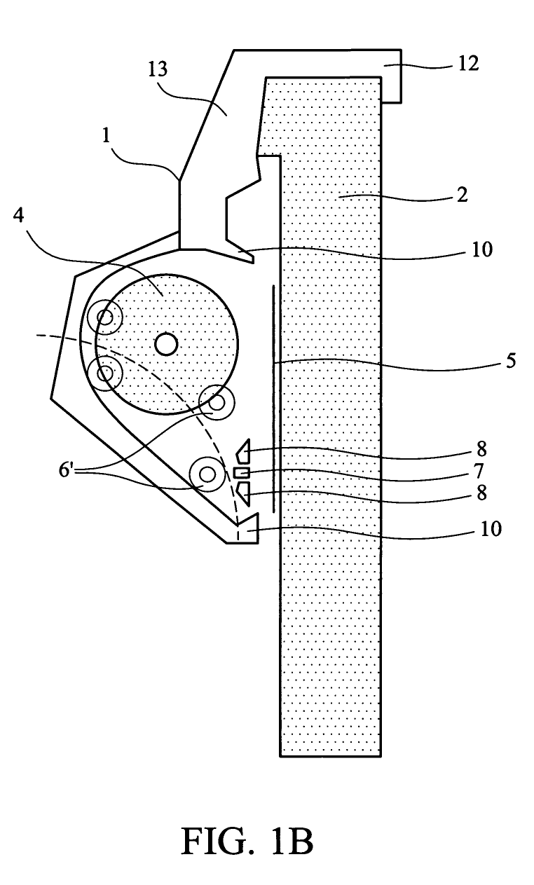

FIG. 1A depicts a scanner of a first embodiment of the invention. Referring to FIG. 1A, the scanner, utilizing light from a display device, comprises a display 2, a scan module 1, and a positioning mechanism 12. The scan module 1 is positioned on the display 2 by the positioning mechanism 12 in a detachable manner, and the display 2 is actuated to provide light for scanning. In the embodiment, the scan module 1 is hung on the display 2 by the positioning mechanism 12, but is not limited thereto. The scan module 1 further comprises a housing 13, a motor 4, a transmission mechanism 6, a contact image sensor 7, a document securing device 10, and a light guide 8, wherein the housing 13 can protect mechanisms disposed therein. The motor 4, the transmission mechanism 6, and the image sensor 7 are disposed in the housing 13, wherein the transmission mechanism 6 is driven by the motor 7. The light guide 8 is also disposed in the housing 13 near the image sensor 7. In the embodiment, the display 2 is a liquid crystal display actuated to provide light for scanning in reflection mode. That is, the image sensor 7 is disposed between a scanning document 3 and the display 2. The document 3 is secured by the document securing device 10. When scanning, the image sensor 7 on the flat-bed transmission mechanism 6 is driven by the motor 4, receiving data carried by reflected light via the document 3. Further, a filter 5 can be disposed between the image sensor 7 and the liquid crystal display 2 to normalize light intensity. Because the image sensor 7 and the display 2 are on the same side of the document 3, the image sensor 7 may block a small portion of light. Accordingly, the light guide 8 can be disposed on one side or both sides of the image sensor 7, improving light intensity.

FIG. 1B depicts the scanner of a second embodiment of the invention. The scanner in FIG. 1B also scans in reflection mode, differing from the scanner in FIG. 1A by a sheet-fed transmission mechanism 6′. As shown in FIG. 1B, a rolling structure of the transmission mechanism 6′ is driven by the motor 4, moving the document 3 forward along a curved path (shown by dashed line in FIG. 1B), executing scanning can be done by movement of the document 3, and the image sensor 7 being fixed. Similarly, the filter 5 can be disposed between the image sensor 7 and the liquid crystal display 2 to normalize light intensity. Because the image sensor 7 and the display 2 are on the same side of the document 3, the image sensor 7 may block a small portion of light. In addition, the light guide 8 can be disposed on one side or both sides of the image sensor 7, improving light intensity.

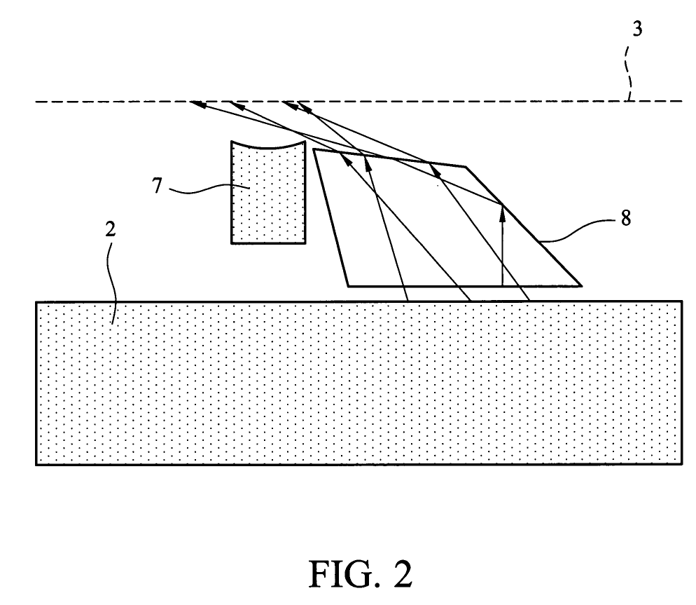

FIG. 2 is a schematic view of the light guide 8 of the scan module 1. The light guide 8 is a converging lens, having the ability to converge light, allowing illumination of document 3 above the image sensor 7. Without the light guide 8, light from the display 2 was not able to be projected to the part of the document above the image sensor 7. The light guide 8 can be made of glass or other transparent material, and disposed on one or both sides of the image sensor 7 according to demand.

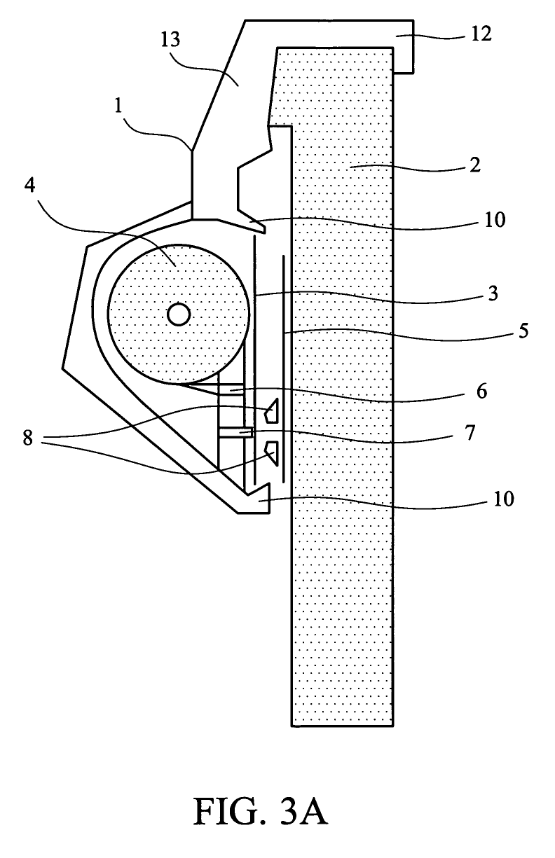

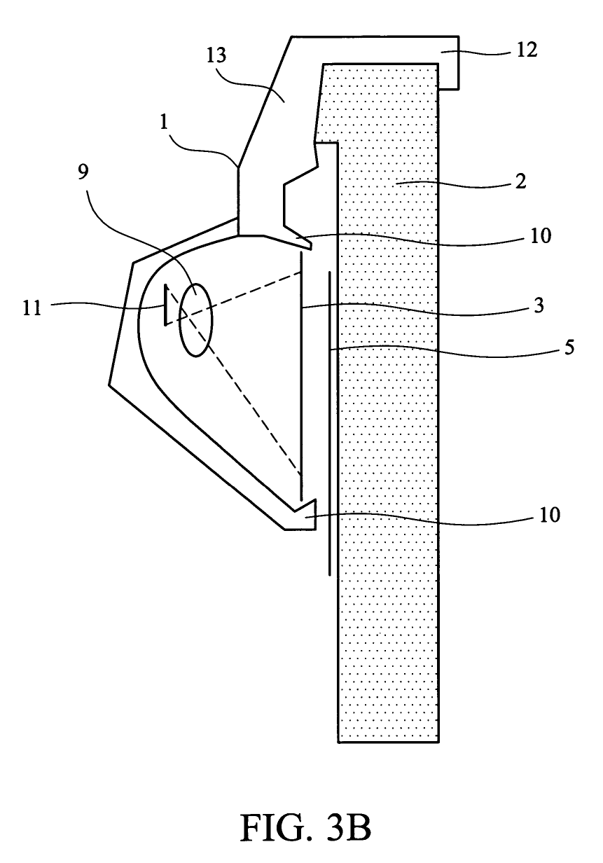

FIG. 3A depicts the scanner of a third embodiment of the invention, differing from that of the above embodiments by scanning in transmission mode. That is, the image sensor 7 and liquid crystal display 2 are on two sides of the document 3 separately. The document 3 is secured by the document securing device 10. When scanning, the image sensor 7 on the flat-bed transmission mechanism 6 is driven by the motor 4, receiving data carried by reflected light via the document 3. Because light from the liquid crystal display decreases with distance, a light guide 8 may be added before data is received by the image sensor 7. The light guide 8 intensifies light transmitting the document 3, which aids receiving ability of the image sensor 7.

FIG. 3B depicts the scanner of a fourth embodiment of the invention. As shown in FIG. 3B, the scanner of this embodiment also scans in a transmission mode. Light from the display 2 transmitted through the document 3 is converged by an area imaging device 9. The area imaging device 9 then planarises motions to form surface light with data from the document 3. A plane array sensor 11 receives the data, obtaining images at once in order to save time.

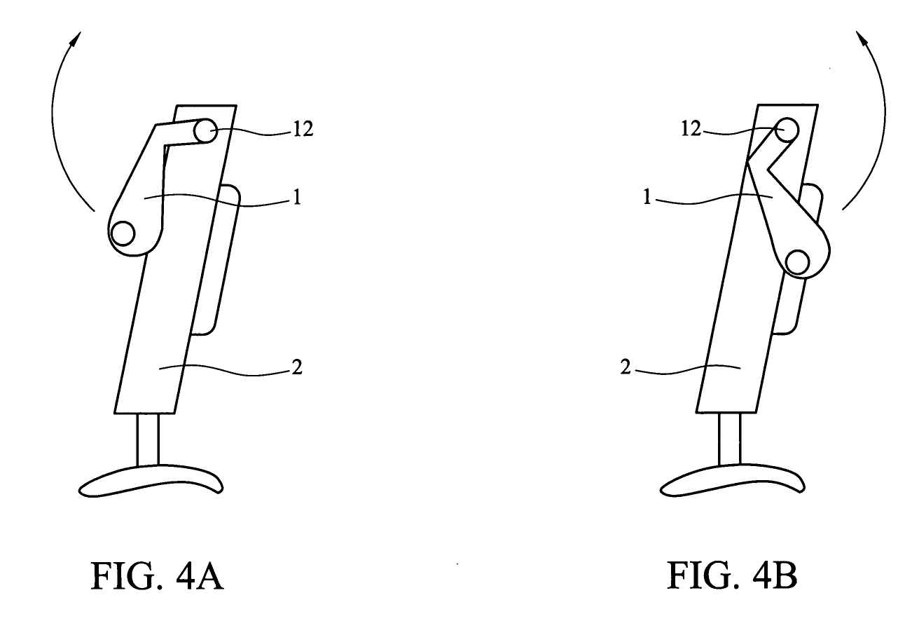

FIGS. 4A and 4B are side views of the scan module in operation and at rest, respectively. The scan module 1 is combined with the display 2 by the positioning mechanism 12. In this embodiment, the positioning mechanism 12 is a hinge. With the disposition of the hinge, the scan module 1 can be stored behind the display 2 when not in use. The scan module 1 rotates to the front of the display 2, such that light from the display 2 is utilized when scanning.

The scanner utilizes light from the liquid crystal display, which acts as a colorful light source providing rapid response control. An optical sensor is combined with the display, and programs control the display and the optical sensor to implement scanning. Like linear array sensors, adjustments can be made before scanning, normalizing light intensity from the display. A surface of the display is scanned before a transmission target to receive data for adjustment. During scanning of a reflection target, a white card disposed in the scanner can be used for adjustment. Exposure is controlled by coordination with scanning by the optical sensor. A computer program designates colors for light. For example, the display can emits white light during scanning, which is then divided by three RGB sensors. Alternatively, only one sensor may be used to control RGB light in designated areas of the display to achieve color scan.

The invention provides a scanner utilizing light conducted by the display device. The scan module, with light guides disposed therein, accurately controls light emitted from the display device, and provides sufficient intense light, creating a multi-functional electronic product.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A scanner, comprising:
a display;
a scan module, comprising an image sensor; and
a positioning mechanism;
wherein the scan module is positioned on the display through the positioning mechanism, and the display is conducted to provide light for scanning a document.

2. The scanner as claimed in claim 1, further comprising a light guide disposed on a side of the image sensor, near the display.

3. The scanner as claimed in claim 2, wherein the light guide is a converging lens.

4. The scanner as claimed in claim 2, wherein the light guide is transparent.

5. The scanner as claimed in claim 2, further comprising a filter disposed between the display and the image sensor, uniforming light from the display.

6. The scanner as claimed in claim 1, wherein the positioning mechanism comprises a hinge connecting the scan module with the display.

7. The scanner as claimed in claim 1, wherein the document is a reflection target or a transmission target.

8. The scanner as claimed in claim 1, wherein the image sensor is a focal plane array sensor.

9. The scanner as claimed in claim 1, wherein the image sensor is a contact image sensor.

10. A scan module for a display device, comprising:
a housing;
a motor, disposed in the housing;
a transmission mechanism, disposed in the housing, driven by the motor;
an image sensor, disposed in the housing; and
a light guide, disposed in the housing, near the image sensor.

11. The scan module as claimed in claim 10, wherein the image sensor is a contact image sensor.

12. The scan module as claimed in claim 10, wherein the light guide is a converging lens.

13. The scanner as claimed in claim 10, wherein the light guide is transparent.

14. A scan module for a display device, comprising:
a housing;
an area imaging device, disposed in the housing; and
an image sensor, disposed in the housing, sensing light conducted by the area imaging device.

15. The scanner as claimed in claim 14, wherein the image sensor is a focal plane array sensor.
